(19) United States
(12) Patent Application Publication
(10) Pub. No.: US 2010/0008655 A1
(43) Pub. Date: Jan. 14, 2010

(54) Hot air welding gun

(76) Inventors: CLINT TACKITT, Springfield, MO (US); XIANGHE PAN, Wenzhou (CN)

Correspondence Address: LATHROP & GAGE LLP, 1845 S. NATIONAL, P.O. BOX 4288, SPRINGFIELD, MO, 65808-4288, US

(21) Appl. No.: 12/381,008

(22) Filed: Mar. 6, 2009

Related U.S. Application Data
(60) Provisional application No. 61/068,631, filed on Mar. 7, 2008.

(51) Int. Cl. F24H 3/04; H05B 3/10

(52) U.S. Cl. 392/385; 219/552

(57) ABSTRACT

A hot air welder capable of reaching temperatures of at least 700° C., comprising a housing with an electric motor, at least one fan for forcibly moving air across a heating element and out of the gun and wherein the heating element is formed from a plurality of electrical wire winding interposed through a series of axially aligned ceramic disks, each disk having a number of circumferentially aligned openings through which the wire windings are oriented and mechanisms for selectively operating the device and electrically controlling the temperature of the heating element.

### RELATED APPLICATION

This Application claims the priority of the provisional patent application Ser. No. 61/068,631 filed Mar. 7, 2008, and incorporates the disclosure of the referenced application herein.

### BACKGROUND

This invention relates to a unique hot air welding gun, more specifically a hand held portable heating gun capable of providing a dynamic stream of heated air at temperatures of up to 700° C. While the innovative hot air welding gun has many suitable purposes, it is particularly well-suited for use in commercial roofing applications. Heat guns are well known and used for a variety of purposes including heating paint for removal, melting glues and wax materials for application, and for heating rubberized roofing materials, tar containing compounds and roofing adhesives for commercial roofing installation.

To date, known heat guns generally have inherent limitations for use, operation, maintenance or longevity. For example, heat guns available through home improvement stores and the like are generally configured for consumers, are generally inexpensive and produce a limited volume of heated air at a relatively low temperature usually not exceeding 250° C. Heating guns with these limitations are ineffective in commercial applications such as commercial roofing installation. Commercial heat guns are often bulky and heavy because the motor, air fan and heating element are generally large and powerful to create the necessary volume of heated air at a required temperature in excess of 500° C. While many available hot air welding guns for roofing installation can adequately heat the air volume and provide enough air flow to accomplish the job, they may require substantial maintenance, replacement of heating elements, or have short life spans. This is typically due to the fragile nature of the known heating elements for use in such devices.

The heating elements are generally of the high-impedance resistance type which radiate high temperatures into a current of air being forcibly moved past the element by a fan. These heating elements can be formed from a variety of materials including electrical coils, magnets and transformers. Heating elements are often insulated in some fashion both for protection of the materials comprising the element, and to control radiation and dissipation of the heat produced by the element.

Common insulating materials include: varnish insulation, polymer coatings and ceramic materials. The preferred insulation material for hot air welding gun heating elements is ceramic. Ceramic, however, is extremely brittle after application on the wire or conductor which forms the heating element and this problem is exacerbated as the ceramic is heated to extremely high temperatures. Further, during use of the welding gun, the ceramic insulation on the heating element is repeatedly heated and cooled, which substantially increases susceptibility of the insulation cracking. Pieces of the ceramic breaking away from the element may injure users as they are blown from the heat gun and can fall into the fan and motor assembly causing damage to the instrument. Generally, when the ceramic begins to crack or break around the heating element, the heating element must be replaced at significant expense. Heat guns which are dropped during use generally suffer damage to the heat element, most notably broken ceramic insulation.

U.S. Pat. No. 6,407,339 to Rice, et al. nicely explains the different types of ceramic materials that may be used to insulate heating elements including a discussion of the drawbacks and problems inherent with ceramic insulation. The novel aspects of the instant innovative device, as disclosed and claimed herein, addresses and overcomes the known problems with the currently known devices.

### SUMMARY

The disclosed hot air welding device overcomes known problems in the industry by utilizing a segmented ceramic insulation on the heating element and through the design and configuration of the ceramic insulator segments further having specific heat dissipating configurations. Further, a unique fan blade assembly positioned between the motor and the heating element causes air to be forced generally outward through the hot air gun housing so that it is forcibly pushed past the heating element. Fans used in heat guns are multi-bladed oscillators which push air uniformly through the heat gun housing and force air generally inward toward and around the heating element.

The hot air welding gun is provided with a tubular housing which contains all of the operable elements of the device. A motor is provided which is powered by alternating current (AC). Accordingly, a standard electrical plug is provided to connect the motor to a power source. The motor is capable of generating a rotational force and providing an electrical current to the heating element. Control of the device is achieved with a common potentiometer. The potentiometer is a variable resister which allows the heating element to be selectively powered to maintain a constant temperature selected by the user. Further, the potentiometer can be used to selectively turn the heating element on or off to maintain the desired constant temperature. A temperature controller is connected to the motor and a temperature control knob which allows the user to select the temperature setting for the heat element and the temperature may then be specifically regulated as described above.

The housing generally includes a plastic handle into which the motor is mounted. A shock proof ring is attached to the plastic handle adjacent the motor drive mechanism. A first fan blade is positioned onto the motor drive shaft and oriented generally within the shock proof ring. A commutate ring is then positioned on the motor drive shaft forward the first fan blade. A second fan blade is then positioned on the motor drive shaft and secured in place with a common fastener such as a screw or bolt and nut assembly.

A heating element is provided which includes two heating element pins, a plurality of metal windings and a segmented ceramic insulator. The heating element is preferably an elongated tube with the heat element pins at a first end. A plurality of heating coils are positioned in concentric rings and connected to the heating pins with wire connectors. The ceramic insulators include a plurality of ceramic disks, each disk having a number of outward radiating spokes between an inner ring and an outer ring. The heating element wires are positioned through the openings formed between each pair of spokes and each successive ceramic disk. The spokes are laterally aligned with the heating coil wires positioned through each disk along the length of the heating element. A thermocouple or sensor pin is provided within the heating element connected to at least one of the heating wire coils to electrically relay temperature to the temperature controller. One or more binding wires may be positioned through the length of the ceramic disk to maintain serial alignment of the disks and to secure them together.

Because the ceramic insulation on the heating element is divided into segments or disks, the heat is dissipated quicker than it would be in a unitary or non-segmented ceramic insulating member. The segmentation substantially decreases the likelihood of breakage during the heating and cooling process or if the device is dropped when the ceramic is hot. Further, the heating element can be easily and inexpensively repaired if a single disk becomes broken in that the single disk can be replaced rather than replacing the entire heating element.

A heating gun barrel is then placed over the heating element which both protects it and allows air forced across the element to be concentrated and projected forward. The barrel is provided with an opening through which heated air is forced.

### BRIEF DESCRIPTION OF THE DRAWINGS

FIG. 1 is a perspective view of an embodiment of the inventive hot air welder gun.

FIG. 2 is an exploded view of one embodiment of the inventive hot air welder gun.

FIG. 3 is an exploded view of an embodiment of the segmented heating element of the hot air welder gun.

FIG. 4 is a side view of one embodiment of the segmented heating element of FIG. 3.

FIG. 5 is a plan view of one embodiment of a ceramic disk of the segmented heating element.

FIG. 6 is a cross sectional view of the segmented heating element.

FIG. 7 is an end view of one embodiment of the segmented heating element with associated connectors.

### DETAILED DESCRIPTION

Referring now generally to the Figures, a hot air welding device 102 is disclosed which includes a segmented ceramic insulator 104 around a heating element 106 with the ceramic insulators 104 having a specific heat dissipating configuration. A unique fan blade 108 positioned between an electrical motor 110 and the heating element 106 causes air to be forced generally outward through a housing 112 which surrounds the heating element 106 so that air is heated as it is forced past the heating element 106. The fan 108 used in the hot air welder is a multi-bladed oscillator which push air uniformly through the housing 112 and forces air generally inward and around the heating element 106.

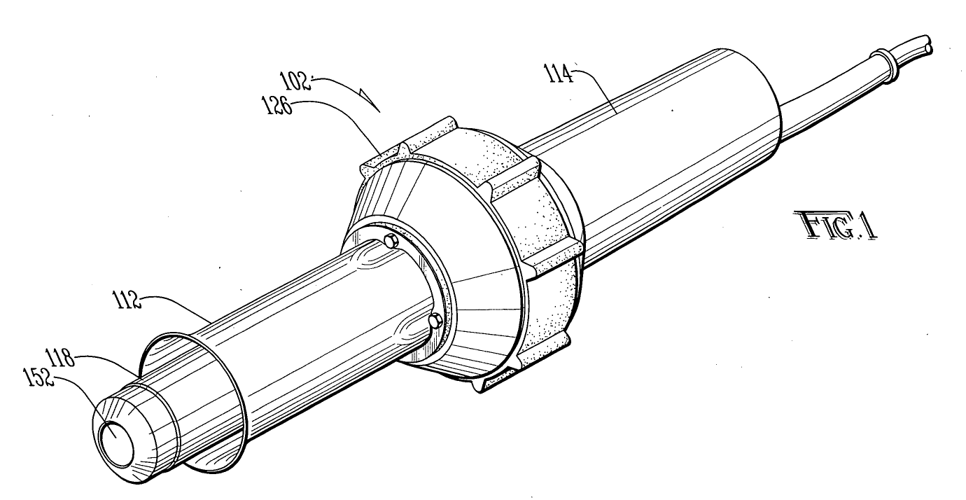

As best shown in FIG. 1, the hot air welding gun 102 is provided with a tubular housing 112 which contains all of the operable elements of the device. The housing 112 has a handle portion 114 which is preferably formed of molded plastic or rubberized material to provide a durable, non-conductive, and easy to grip surface, a fan shroud 116 and a heat tube 118. The motor 110 is mounted onto the handle 114 and is powered by alternating current (AC). A standard electrical plug and cord are provided to connect the motor 110 to a power source.

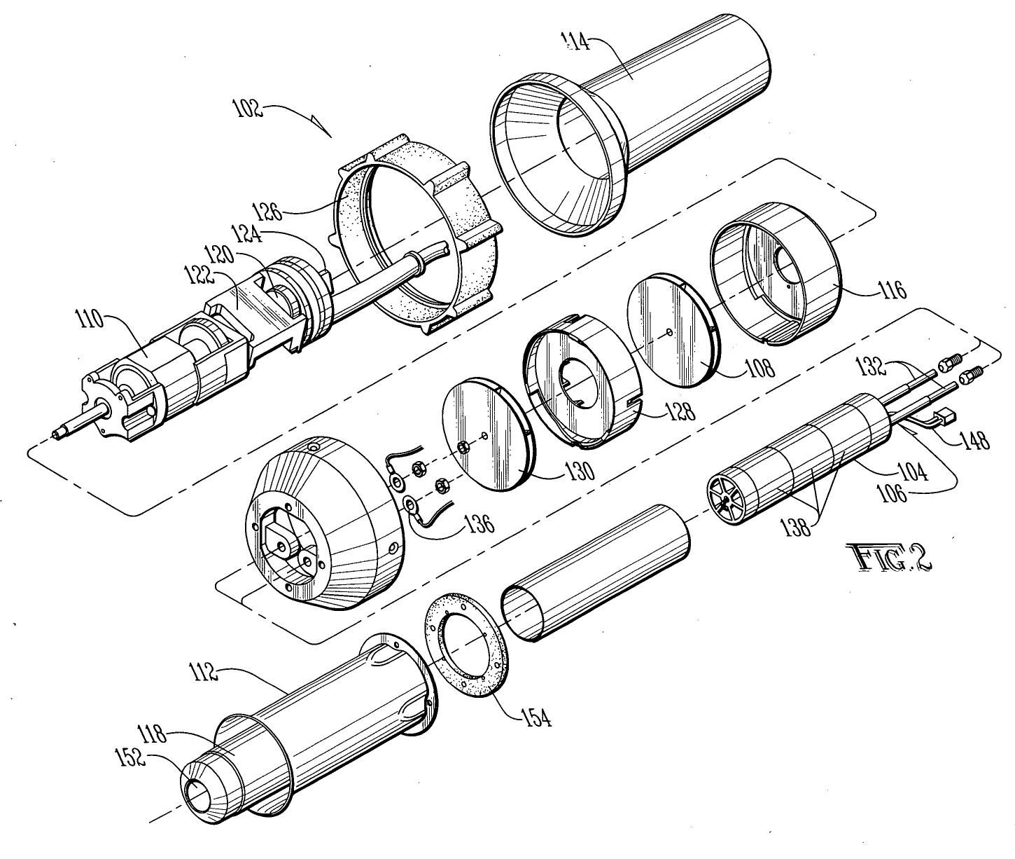

As best shown in FIG. 2, the motor 110 generates rotational force and provides electrical current to the heating element 106 which is controlled via a potentiometer 120. The preferred potentiometer 120 is a variable resister type which allows the heating element 106 to be selectively powered to maintain a constant heat selected by the user. Further, the potentiometer 120 can be used to selectively turn the heating element 106 on or off as needed to maintain a constant temperature.

A temperature controller 122 is electrically connected to the motor 106 and a temperature control knob 124 which allows the user to select the temperature setting for the heat element 106. A shock proof ring 126 surrounds the fan shroud 116 and interposes the handle 114 and tube 118. The fan blade 108 is rotatably mounted to the motor 110 on a provided drive shaft, and positioned within the shroud 116. A commutate ring 128 is then positioned on the motor drive shaft forward the fan blade 108. A second fan blade 130 is then be mounted on the motor drive shaft and secured in place with a common fastener such as a screw or bolt and nut assembly.

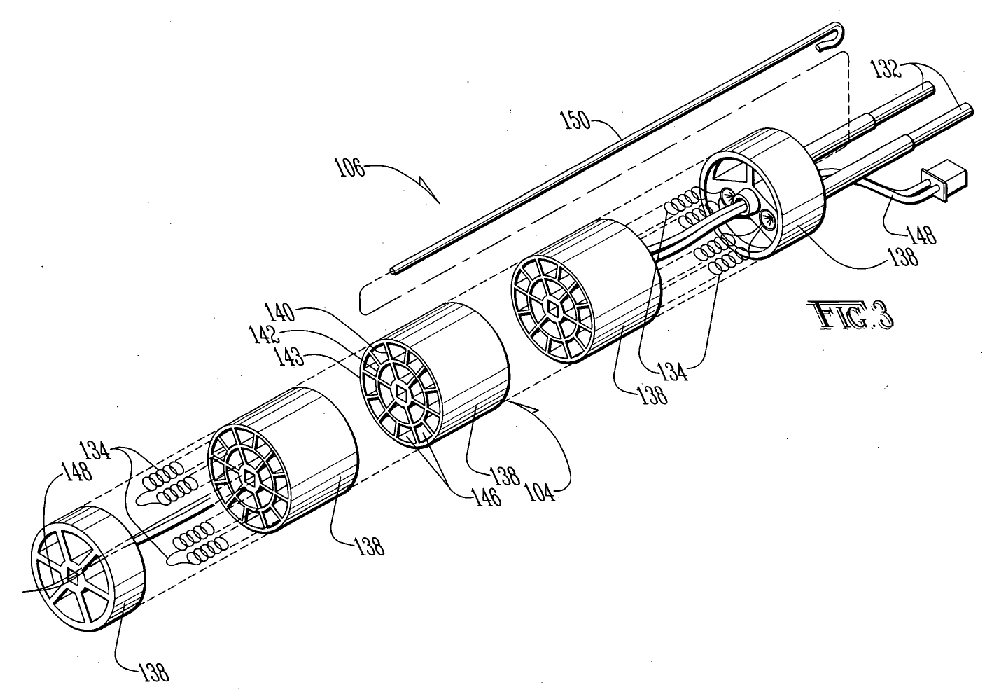

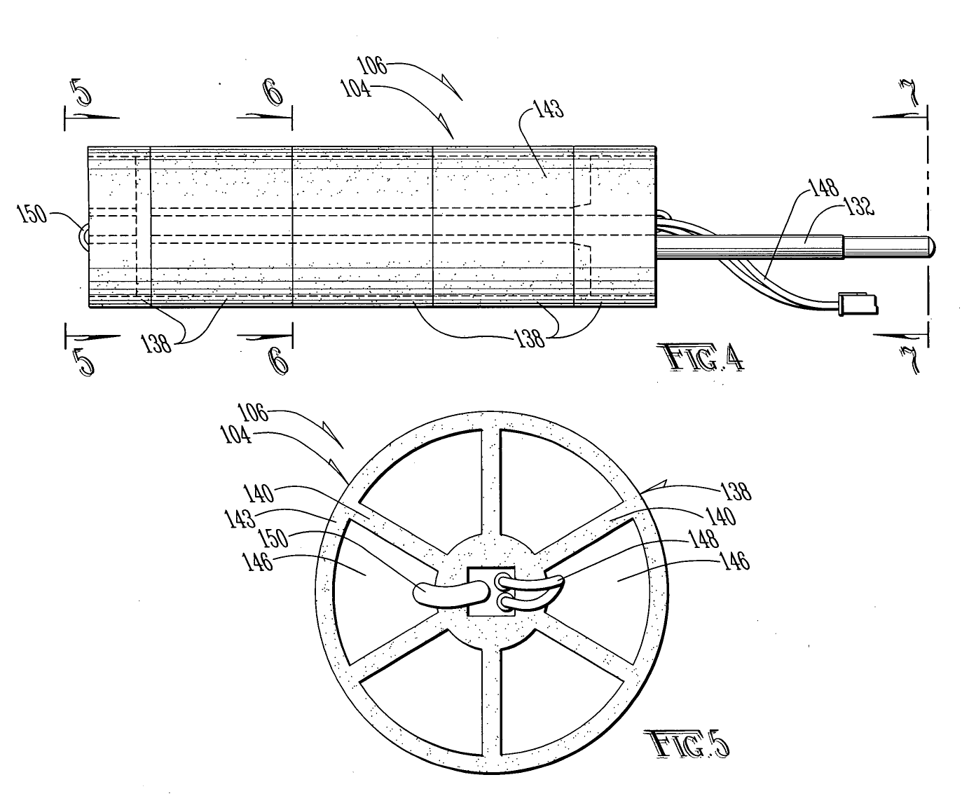

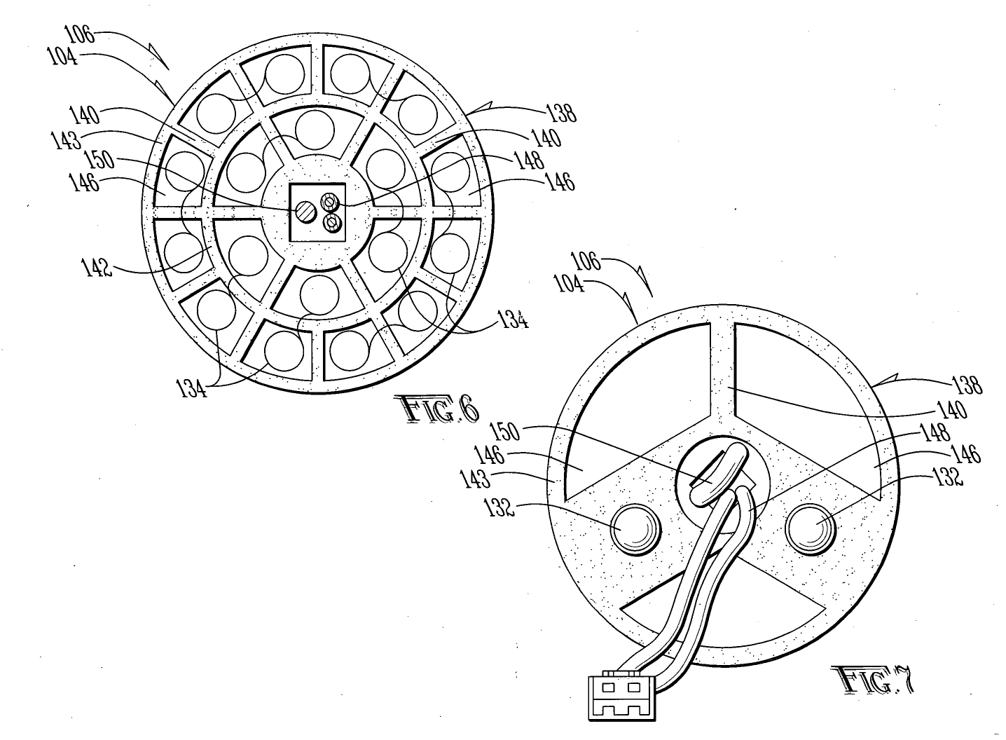

As shown in FIGS. 3 and 4, the heating element 106 includes two heating element pins 132, a plurality of metal windings 134 and the segmented ceramic insulator 104. The heating element 106 is preferably an elongated tube with the heat element pins 132 at a first end. The plurality of heating coils or windings 134 are positioned in concentric rings and connected to the heating pins 132 by wire connectors 136 as shown in FIG. 6. The ceramic insulator further comprises a plurality of ceramic disks 138, each disk having a number of outward radiating spokes 140 between an inner ring 142 and an outer ring 143 as shown in FIG. 5. Additional spokes and rings can be formed in each disk to maximize the disk surface area which aids in heat dissipation. The insulator disks 138 are preferably formed from an aluminum compound, such as Al₂O₃ which is available under the trade name Alumina. The metal windings 134 are positioned within the openings 146 formed between each pair of spokes 140 and each ceramic disk as shown in FIG. 6. The spokes 140 are laterally aligned with the heating coil wires 134 positioned through each disk 138 of the segmented insulator 104 along the length of the heating element 106. A thermocouple 148 or sensor pin is provided within the heating element 106 connected to at least one of the coils 134 to electrically relay temperature to the temperature controller 122 as shown in FIG. 7. One or more binding wires 150 may be positioned through the length of the segmented insulator 104 to maintain serial alignment of the disks 138 and further secure them together.

Because the ceramic insulation 104 on the heating element 106 is divided into segments or disks 138, the heat is dissipated quicker than it would be in a unitary or non-segmented ceramic insulating member. The segmentation further decreases the likelihood of breakage during the heating and cooling process or if the device is dropped when the ceramic is hot. Further, the heating element can be easily and inexpensively repaired if a single disk becomes broken in that the single disk can be replaced rather than replacing the entire heating element.

Referring again to FIG. 1, a gun barrel or tube 118 of the housing 112 overlies the heating element 106 which both protects it and allows air forced across the element 106 to be concentrated and projected forward. The tube 118 is provided with an opening 152 through which heated air is forced. One or more washers or spacers 154 may be positioned within the tube 118 to maintain the axial alignment of the heating element 106 within the tube 118 and to further increase rigidity which contributes to the life of the heating element 106 by preventing it from moving within the tube 118.

In one embodiment, a mica wrap (not shown) is mounted around the ceramic disks 138 to further allow rapid dissipation of heat. For some applications a shield may be provided between the fan and the heating element to prevent air from being forced through the ceramic discs and to divert the air flow to the outer periphery of the discs.

Further modifications of the inventive device could be made within the scope of the invention which is limited only by the claims hereto.

What is claimed is:

1. A hot air welding gun comprising a generally hollow motor housing removably coupled to a generally hollow heat element housing, an electrical motor disposed in the motor housing wherein the electrical motor is operably connected to a heating element disposed in the heating element housing, at least one fan interposed the motor and the heating element for forcibly driving air past the heating element and out of the heating element housing; the heating element further comprising at least one pin connected to the motor, a plurality of metallic wire windings and a plurality of partially hollow ceramic disks where the metallic windings are concentrically oriented through the hollows in each ceramic disk, and a temperature sensing pin is connected to the heating element and is in electrical communication with a temperature control device operatively connected to the motor and wherein the temperature control device is connected to a temperature control switch which allows an operator to selectively control the temperature of the heating element during operation.

2. The hot air welder of claim 1 further comprising at least two fan blades interposed the motor and the heating element for forcibly moving air past the heating element and out of the heating element housing.

3. The hot air welder of claim 1 further comprising a shock proof ring interposed the motor housing and the heating element housing.

4. The hot air welder of claim 1 further comprising a potentiometer connected to the motor for variably controlling operation of at least one fan upon the heating element reaching a predetermined temperature.

5. The hot air welder of claim 1 further comprising a heat dissipating tube overlying the heating element housing.

6. The hot air welder of claim 1 further comprising a mica wrap overlying the ceramic disks for encouraging the rapid dissipation of heat.

7. The hot air welder of claim 1 further comprising at least one washer positioned over the heating element which medially aligns the heating element within the heating element housing.

8. The hot air welder of claim 1 further including a shield at the upstream end of the heating element for generally precluding air flow through the hollows of the ceramic disks and for diverting air flow through the annular space between the outer most periphery of the heating element and the inner surface of the heating element housing.

9. A hot air welder comprising: a housing, an electrical motor disposed in said housing, a fan in said housing operably connected to the electric motor, a heating element comprising a plurality of electric windings positioned within a plurality of partially hollow ceramic disks, where the ceramic disks are axially aligned and wherein the heating element further includes a connection to the electric motor, a tubular housing coaxially surrounding the heating element and having opposed first and second ends, the first end secured to the housing and the second end oriented away from the housing and defining an air outlet at its terminal end, and wherein the heating element tube is spaced apart from the periphery of the heating element thereby defining an annular air flow path therebetween through which heated air is forced by the fan.

10. The hot air welder of claim 9 further comprising at least two fan blades interposed the motor and the heating element for forcibly moving air past the heating element and out of the heating element housing.

11. The hot air welder of claim 9 further comprising a shock proof ring interposed the motor housing and the heating element housing.

12. The hot air welder of claim 9 further comprising a potentiometer connected to the motor for variably controlling operation of at least one fan upon the heating element reaching a predetermined temperature.

13. The hot air welder of claim 9 further comprising a heat dissipating tube overlying the heating element housing.

14. The hot air welder of claim 9 further comprising a mica wrap overlying the ceramic disks for encouraging the rapid dissipation of heat.

15. The hot air welder of claim 9 further comprising at least one washer positioned over the heating element to medially align the heating element within the housing.

16. The hot air welder of claim 9 further including a shield at the upstream end of the heating element for generally precluding air flow through the hollows of the ceramic disks and for diverting air flow through the annular space between the outer most periphery of the heating element and the inner surface of the heating element housing.

17. A heating element for a hot air welder, comprising: at least one pin having a first end for connecting to an electrical power source and a second end electrically coupled to a plurality of electrical windings, and a plurality of partially hollow heat dissipating disks axially aligned with and at least partially overlying the electrical windings.

18. The heating element of claim 17 further comprising a thermocouple for electrically connecting the heating element to a temperature sensor for monitoring and maintaining a desired temperature of the heating element.

19. The heating element of claim 17 wherein each disk includes an inner annular wall and a spaced apart outer annular wall with a plurality of spokes connecting the inner and outer walls to form openings axially through the disk.

20. The heating element of claim 17 wherein the plurality of electrical windings are generally oriented through the axially aligned openings of each disk and wound around the plurality of spokes positioned between the inner and outer walls.

21. The heating element of claim 17 further comprising at least one wire tie positioned through the axially aligned disks to maintain the disk spacing and orientation.

22. The heating element of claim 17 wherein each disk is formed from a ceramic material.

23. The heating element of claim 17 wherein the ceramic material is formed from an aluminum compound.

24. A hot air welding gun comprising a generally hollow housing, an electrical motor connected to a heating element, both of which are disposed in the housing, at least one fan interposed the motor and the heating element for forcibly driving air past the heating element; the heating element further comprising a plurality of metallic windings concentrically oriented through at least one partially hollow ceramic heating disk; a temperature sensing pin connected to the heating element and is in electrical communication with a temperature control device operatively connected to the motor which allows an operator to selectively control the temperature of the heating element during operation.

25. The hot air welding gun of claim 24 further comprising an electrical mechanism for selectively adjusting the rotational speed of the at least one fan.

26. The hot air welding gun of claim 24 wherein the partially hollow heating element disk comprises from between 3 and 9 disk segments.

27. The hot air welding gun of claim 26 wherein each disk segment is replaceable.
